(19) United States
(12) Patent Application Publication
(10) Pub. No.: US 2006/0169532 A1
(43) Pub. Date: Aug. 3, 2006

(54) Acoustic liner with nonuniform impedance

(76) Inventor: William P. Patrick, Glastonbury, CT (US)

Correspondence Address: PRATT & WHITNEY, 400 MAIN STREET, MAIL STOP: 132-13, EAST HARTFORD, CT, 06108, US

(21) Appl. No.: 11/049,764

(22) Filed: Feb. 3, 2005

(51) Int. Cl. E04H 17/00; G10K 11/00; B64F 1/26; B64D 33/02

(52) U.S. Cl. 181/210; 181/214

(57) ABSTRACT

A fluid handling duct such as a turbine engine inlet duct 20 includes an acoustic liner 32 comprising a face sheet 34 and a backwall 38 laterally spaced from the face sheet. The liner has a nonuniformly distributed acoustic impedance to direct sound waves incident on the backwall in a prescribed direction relative to the face sheet. The nonuniform impedance is spatially distributed to regulate the direction in which noise signals reflect from the backwall, thereby reducing noise propagation from the duct to the surrounding environment.

### CROSS REFERENCE TO RELATED APPLICATIONS

This application includes subject matter in common with commonly owned, co-pending application entitled “Acoustic Liner with a Nonuniform Depth Backwall” (Assignee's docket number EH-11410) filed concurrently herewith.

### TECHNICAL FIELD

This invention relates to noise attenuating liners for fluid handling ducts such as the inlet and exhaust ducts of turbine engines.

### BACKGROUND OF THE INVENTION

Turbine engines, such as those used for aircraft propulsion, include an inlet duct for delivering air to the engine and an exhaust duct for discharging combustion products to the atmosphere. During operation, the engine generates noise that propagates to the environment through the open ends of the ducts. Because the noise is objectionable, engine manufacturers install acoustic liners on portions of the interior walls of the ducts. A commonly used type of acoustic liner features an array of resonator chambers sandwiched between a perforated face sheet and an imperforate backwall. The liner is installed in the duct so that the face sheet defines a portion of the interior wall surface and is exposed to the air or combustion products flowing through the duct. Acoustic liners are designed to reduce the amplitude of the noise across a bandwidth of frequencies referred to as the design frequency band.

Acoustic liners are not completely effective. Noise at frequencies outside the design frequency band are unaffected by the liner. Even noise within the design frequency band persists, albeit at a reduced amplitude. The residual noise, whether attenuated or not, can be reflected by the liner. Some of the noise decays too rapidly with distance to propagate outside the ducts. These decay susceptible noise modes are referred to as “cut-off” modes and are not of concern. Other noise modes are decay resistant and can easily propagate long distances. These are referred to as “cut-on” modes. If a decay resistant noise signal strikes the liner at a shallow enough angle, the noise signal can reflect at a similar shallow angle and can propagate out of the duct.

One way to attenuate the cut-on modes is to regulate the direction in which the liner reflects those modes. For example, if a decay resistant noise signal strikes the liner at a shallow angle, and does so far from the open end of the duct (i.e. remote from the intake plane of an inlet duct or remote from the exhaust plane of an exhaust duct) it could be beneficial to reflect that signal at a steeper angle, i.e. in a less axial direction. The principal benefit of the steeper reflection angle is that it causes the noise signal to experience repeated reflections off the liner as the signal propagates toward the open end of the duct. This is beneficial because each interaction with the liner further attenuates the noise signal, provided the frequency of the signal is within the design frequency band of the liner. Moreover, the reflected signal decays exponentially with distance due to the inability of sound at that frequency to propagate in the duct at that angle.

It may also be beneficial to reflect a noise signal into a direction more axial than the direction of the incident signal. For example if a noise signal strikes the liner close to the open end of the duct (i.e. near the intake plane of an inlet duct or near the exhaust plane of an exhaust duct) the axial distance between the point of incidence and the open end of the duct may be too small to intercept a reflected signal, even one reflected at a steep angle. Therefore, it may be more beneficial to reflect that signal in a more axial direction. This is because noise that propagates axially from an aircraft engine spreads out over a larger area before reaching the ground than does noise that propagates nonaxially from the engine. The resulting wider distribution of the noise reduces its amplitude, making it less disturbing to observers on the ground.

One known way to regulate the angle of reflection is to employ an active backwall. An active backwall includes vibratory elements such as piezoelectric flat panel actuators. A control system responds to acoustic sensors deployed on the liner by signaling the actuators to vibrate at an amplitude and a phase angle (relative to an incident noise signal) that causes the impedance of the liner to vary with time and to do so in a way that optimizes attenuation of an incident noise signal. However such liners are not completely satisfactory because their capability is limited by the power available to drive the actuators. Moreover, the active backwall introduces unwelcome weight, cost and complexity.

In principle, an engine designer can orient the entire liner (i.e the face sheet and the backwall) so that the liner reflects incident noise signals in one or more desired directions. However doing so is almost always impractical because the interior shape of the duct is governed by aerodynamic considerations. Because the liner face sheet defines at least part of the contour of the duct interior wall, orienting the entire liner to regulate the direction of reflected noise will almost always compromise the aerodynamic performance of the duct.

What is needed is a way to redirect reflected noise in a duct without introducing undue weight, cost or complexity and without jeopardizing the aerodynamic performance of the duct.

### SUMMARY OF THE INVENTION

It is, therefore, an object of the invention to redirect reflected noise in a duct without introducing undue weight, cost or complexity and without jeopardizing the aerodynamic performance of the duct.

According to one aspect of the invention, a fluid handling duct has a nonuniform acoustic impedance spatially distributed to direct sound waves incident upon the backwall in a prescribed direction relative to the face sheet.

In one detailed embodiment of the invention, the liner includes a face sheet and the nonuniform impedance is attributable to a spatially nonuniform porosity of the face sheet.

The foregoing and other features of the various embodiments of the invention will become more apparent from the following description of the best mode for carrying out the invention and the accompanying drawings.

### BRIEF DESCRIPTION OF THE DRAWINGS

FIG. 1 is a schematic view of a gas turbine engine inlet duct including an acoustic liner taken in the direction 1-1 of FIG. 2, i.e. looking parallel to the duct axis.

FIG. 2 is a cross sectional side elevation view in the direction 2-2 of FIG. 1.

FIG. 3 is an enlarged view of the region 3-3 of FIG. 2 showing reflection of an approaching noise signal at an angle of reflection steeper than the angle of incidence.

FIG. 4 is a view taken in the direction 4-4 of FIG. 2 or FIG. 3. showing a portion of the acoustic liner having a nonuniform acoustic impedance attributable to perforations that increase in size with increasing axial distance from a noise source.

FIG. 5 is a view looking in the direction 5-5 of FIG. 1.

FIG. 6 is an enlarged view of the region 6-6 of FIG. 5 showing reflection of an approaching noise signal at an angle of reflection shallower than the angle of incidence .

FIG. 7 is a view taken in the direction 7-7 of FIG. 5 or FIG. 6 showing a portion of the acoustic liner having a nonuniform acoustic impedance attributable to perforations that decrease in size with increasing axial distance from a noise source.

FIG. 8 is a view similar to FIG. 3 illustrating the physical behavior of the inventive acoustic liner.

FIG. 9 is a view similar to FIG. 4 showing a portion of an acoustic liner having a nonuniform acoustic impedance attributable to perforations that change in size in both an axial and a circumferential direction.

FIG. 10 is a view similar to FIG. 3 showing an acoustic liner with a nonuniform acoustic impedance in combination with an oblique backwall.

FIG. 11 is a view similar to FIG. 3 showing an acoustic liner with a nonuniform acoustic impedance in combination with a stepped backwall.

FIG. 12 is a view similar to FIG. 3 showing an acoustic liner with a nonuniform acoustic impedance in combination with an active backwall.

FIG. 13 is a schematic, cross sectional side elevation view of a turbine engine exhaust nozzle with an acoustic liner having a spatially nonuniform impedance.

### BEST MODE FOR CARRYING OUT THE INVENTION

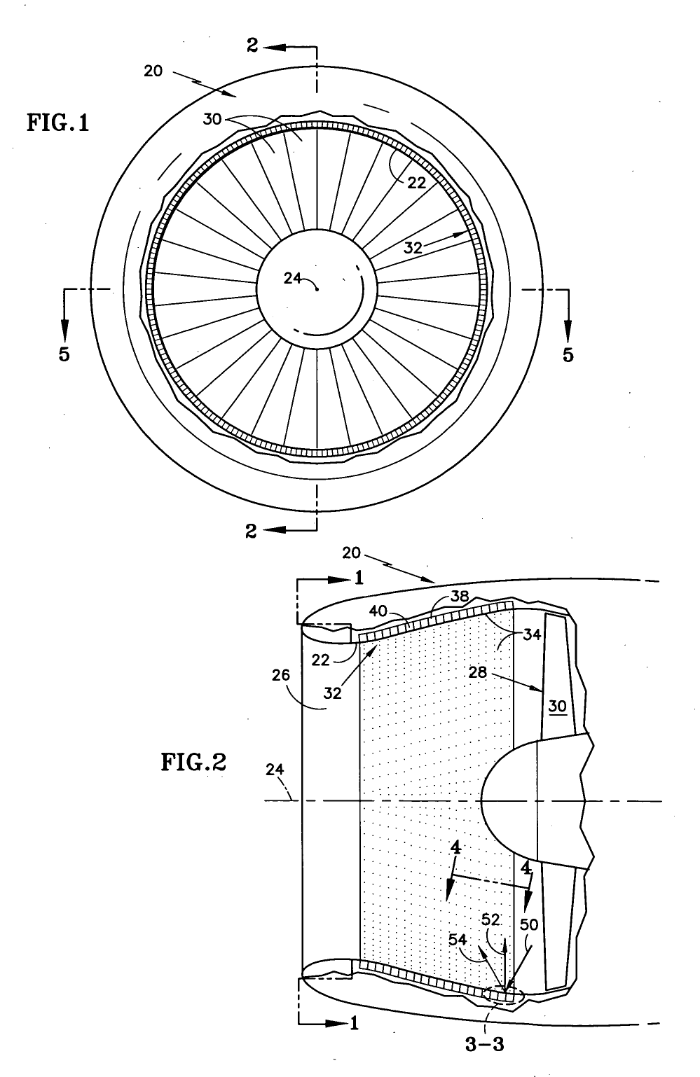

FIGS. 1, 2 and 5 illustrate a turbine engine inlet duct 20 defined by duct interior wall 22, which circumscribes a duct axis 24. The illustrated inlet duct is substantially circular in cross section when viewed parallel to the engine axis, although some inlet ducts have a noticeably less circular shape. One end 26 of the duct is open to the atmosphere. The other end of the duct, which is axially offset from the open end, is immediately forward of a compressor represented by a rotatable fan 28 having an array of blades 30. During engine operation the fan is a source of noise, some of which is attenuated by an acoustic liner as already described.

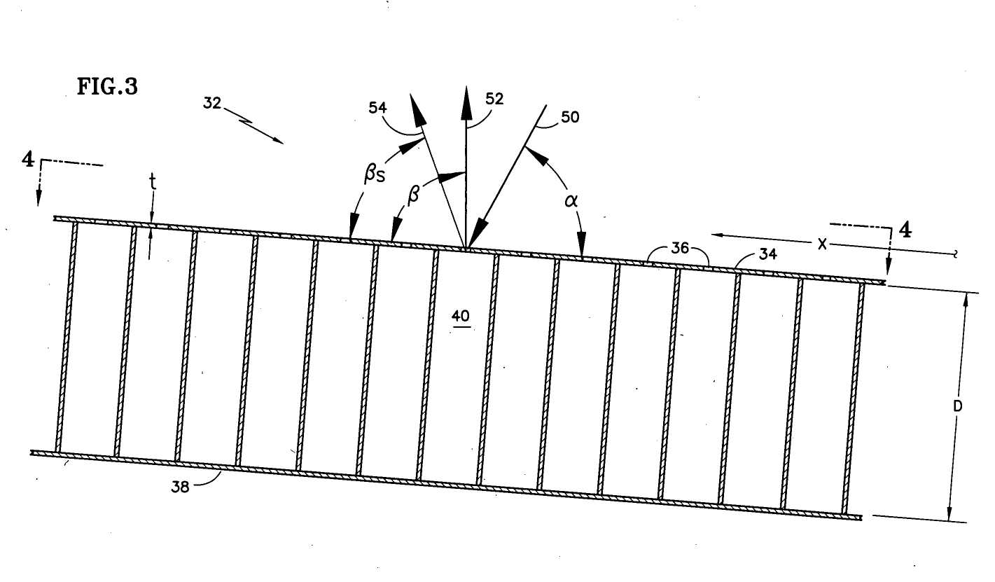

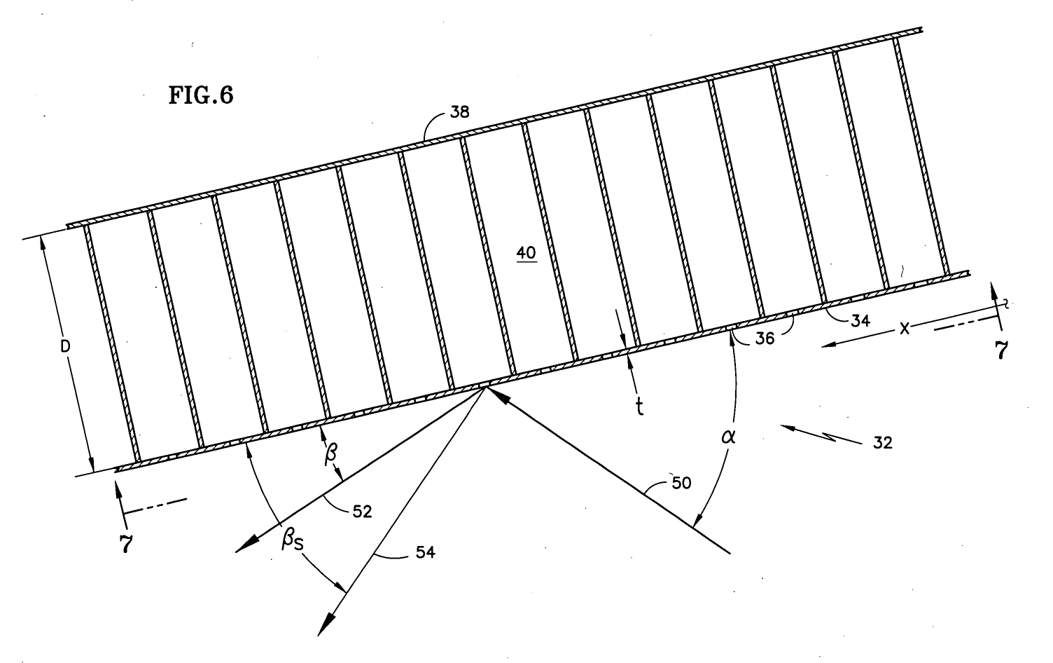

Portions of the duct interior wall 22 are lined with an acoustic liner 32. A typical acoustic liner comprises a face sheet 34 perforated by numerous small holes 36 (visible in FIGS. 3, 4, 6 and 7) and an imperforate back sheet or backwall 38 laterally spaced from the face sheet. The face sheet defines the interior contour of the duct wall as seen best in FIGS. 2 and 5. An array of resonator chambers 40 or other sound attenuator occupies the space between the face sheet and the backwall. In many acoustic liners the resonator chambers are referred to as honeycomb cells because they each have a hexagonal or honeycomb shape as seen by an observer looking in direction 4-4 or 7-7. The liner backwall 38 is offset from the face sheet by a depth D (FIGS. 3 and 6). The depth may be uniform, as shown, or it may be nonuniform in which case the nonuniform depth may be used to regulate the direction of reflection as described more completely in my copending, commonly owned application (Assignee's docket number EH-11410) entitled “Acoustic Liner with a Variable Depth Backwall” and filed concurrently herewith, the contents of which are incorporated herein by reference.

The effectiveness of the liner depends on a property known as acoustic admittance, which is a measure of the ability of the liner to admit an acoustic disturbance into the chambers 40 so that the disturbance can be attenuated. Alternatively, the inability of a liner to admit and attenuate a disturbance is referred to as acoustic impedance. Acoustic impedance Z is a complex quantity having a real component known as resistance R and an imaginary component known as reactance X, i.e. Z=R+iX. Acoustic impedance is related to a time constant τ, which is the period of time it takes a sound wave to enter the liner, reflect from the backwall and re-emerge from the face sheet. The time constant τ is primarily a function of the reactance component of the acoustic impedance.

For a liner as shown in FIG. 3 or FIG. 6, the following relationships interrelate the time constant τ, the liner parameters, the liner impedance and distance x along the liner. The impedance of the face sheet depicted in FIG. 3 or 6,is given by the equation:
Z=R+iX (1)
where Z is the impedance, R is the resistance, and X is the reactance. The reactance term can be expressed as

$$X = ω M - \frac{1}{ω C} \qquad ( 2 )$$

where ω is the angular frequency of the noise signal of interest (i.e ω=2nf where f is the frequency of the noise signal) M is the acoustic inertance, and C is the acoustic compliance of the liner. Conversely, since the liner time constant is the inverse of the response frequency of the liner, i.e.

$$ω = 2 π f = \frac{2 π}{τ} \qquad ( 3 )$$

the liner time constant can be determined from the following quadratic equation, which is obtained by multiplying equation (2) by ω:

$${ω}^{2} M - ω X - \frac{1}{C} = 0 \qquad ( 4 )$$

Substituting ω from equation (3) yields:
τ²+2nCX τ−4n²CM =0 (5)
for a given value of the liner reactance X.
Solving the quadratic equation yields an expression for the time constant:

$$τ = π CX ( \sqrt{1 + \frac{4 M}{{CX}^{2}} - 1} ) \qquad ( 6 )$$

Near resonance the reactance X will approach zero. The near-resonant condition allows determination of the resonant frequency, which is inversely proportional to the time delay of the liner. Accordingly:

$$\frac{4 MC}{{X}^{2}} ⪢ 1 ⇒ τ = 2 π \sqrt{MC} \qquad ( 7 )$$

To first order, the inertance and compliance can be expressed in liner and aerodynamic parameters as:

$$\begin{matrix}M = \frac{ρ {t}^{′}}{S} \\ and & ( 8 ) \\ C = \frac{V}{ρ {c}^{2}} & ( 9 )\end{matrix}$$

where:
ρ=air density;
S=area of hole (or holes) in the face sheet leading to each individual resonator chamber;
V=volume of each individual resonator chamber;
c=speed of sound; and
t′=t+δₑ where:
t is the physical thickness of the liner face sheet; and

$${δ}_{e} = \frac{8 {d}_{h}}{{3}_{π} }$$
where δₑ is an “end correction” for the holes 36 in face sheet; and dₕ is the diameter of the individual holes 36 in the face sheet (assuming circular holes).
   The “end correction” referred to above is also referred to in acoustics texts as the mass loading at the ends of the opening into the resonator. The correction accounts for additional mass in the near field of the exit plane of the hole. The sound wave has to move that mass in addition to moving all the mass in the hole when it oscillates in the resonator neck.

As seen from the above, the acoustic impedance Z is directly proportional to the acoustic inertance M, which is inversely proportional to the open area of the face sheet. Thus the acoustic impedance is also inversely proportional to the area of the holes.

Resonance occurs when the acoustic reactance equals zero. At resonance the time constant is given by the relation:

$$\begin{matrix}τ = 2 π \sqrt{MC} \\ = \frac{2 π}{c} {( \frac{{Vt}^{′}}{S} )}^{1 / 2} \\ = \frac{2 π}{c} {( \frac{V ( t + \frac{8 {d}_{h}}{3 π} )}{S} )}^{1 / 2} \\ = \frac{2 π}{c} {( \frac{D ( t + \frac{8 {d}_{h}}{3 π} )}{σ} )}^{1 / 2}\end{matrix} \qquad ( 10 )$$

where D is the depth of the liner and σ is the fractional open area (i.e. the porosity) of the liner face sheet

Thus, at resonance the time constant is inversely proportional to the area of the holes and to the liner open area ratio (porosity). It is also directly proportional to the liner depth D.

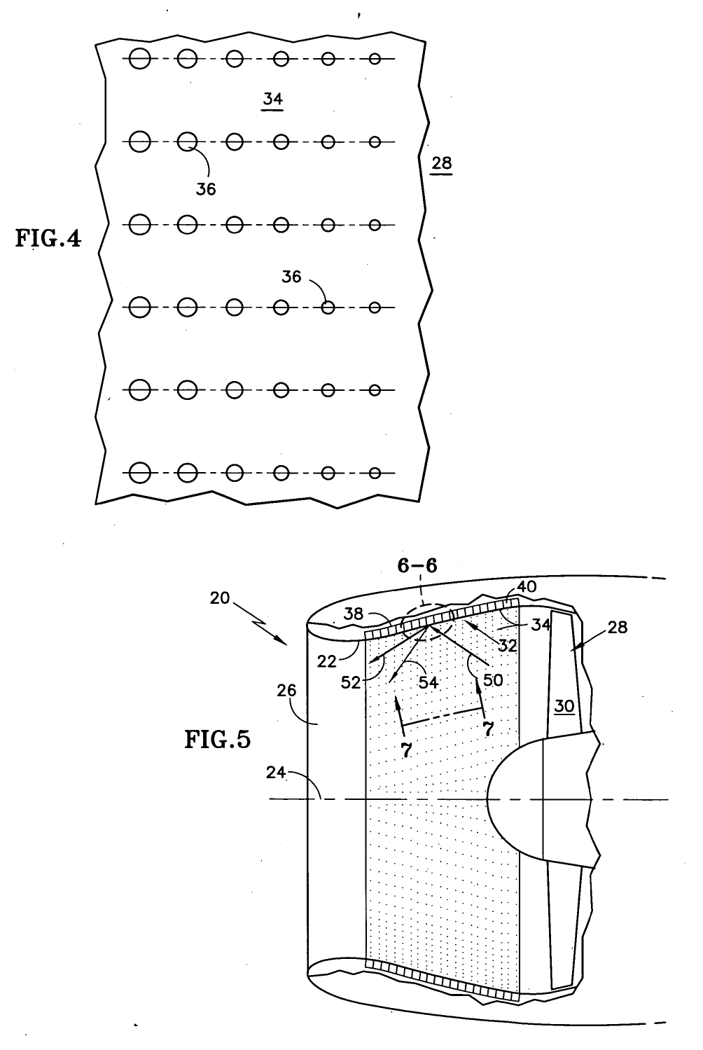

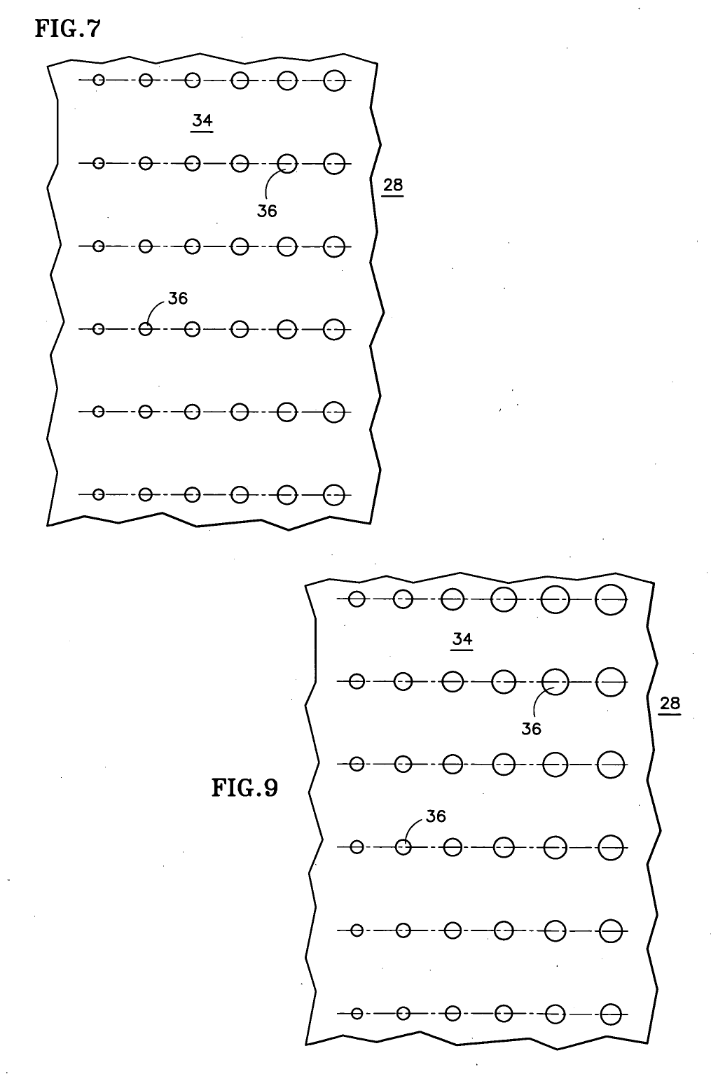

Referring to FIGS. 4 and 7, the liner 32 has a spatially nonuniform acoustic impedance. In FIG. 4, the impedance and the liner time constant decrease with increasing axial distance away from the noise source 28. The impedance decrease is attributable to an increase in the area of holes 36, i.e. an increase in porosity of the face sheet, with axial distance away from the noise source. In FIG. 7 the impedance and liner time constant increase with increasing axial distance x away from the noise source 28. The impedance increase is attributable to a decrease in the area of holes 36, i.e. a decrease in porosity of the face sheet, with axial distance x away from the noise source. As will be described in more detail below, the spatial distribution of the impedance, and hence of the liner time constant, is selected to direct sound waves incident on the face sheet into a prescribed direction relative to the face sheet.

Referring to FIGS. 2-4, a representative sound wave or noise signal 50 produced by the fan propagates forwardly through the inlet duct. The trajectory of the illustrated noise signal is describable by a directional component parallel to the face sheet 34 (and therefore approximately axial) and a directional component perpendicular to the face sheet (and therefore approximately radial). The illustrated noise signal strikes the liner at an angle of incidence a and does so far from the open end 26 of the inlet duct. The nonuniform impedance, which in this case decreases with increasing distance away from the noise source, reflects any residue of the incident noise signal 50 in a prescribed direction as indicated by reflected signal 52 and its associated angle of reflection β. If the impedance were spatially uniform, the signal would have reflected at a specular angle of reflection βₛ equal to the incidence angle α and propagated along a specular trajectory 54, i.e. a trajectory whose directional components parallel and perpendicular to the face sheet 34 are equal in magnitude to the corresponding directional components of the incident signal 50. However, as seen in FIGS. 2 and 3, the inventive liner causes the parallel directional component of the reflected signal 52 to be lower in magnitude than the parallel directional component of the incident signal, and the perpendicular directional component of the reflected signal to be greater in magnitude than the perpendicular directional component of the incident signal. In other words the reflected trajectory is steeper than the incident trajectory. As a result, the reflected signal has more opportunities to repeatedly reflect off the liner as it propagates toward the open end of the duct, which provides repeated opportunities for the liner to attenuate the noise signal.

FIGS. 5-7 are similar to FIGS. 2-4 but show a noise signal 50 striking the liner near the open end 26 of the inlet duct. The nonuniform impedance, which in this case increases with increasing distance away from the noise source reflects any residue of the incident noise signal 50 in a prescribed direction as indicated by reflected signal 52 and its associated angle of reflection β. If the impedance were spatially uniform, the signal would have reflected at a specular angle of reflection βₛ equal to incidence angle α and propagated along a specular trajectory 54, i.e. a trajectory whose directional components parallel and perpendicular to the face sheet 34 are equal in magnitude to the corresponding directional components of the incident signal. However, as seen in FIGS. 5 and 6, the inventive liner causes the parallel directional component of the reflected signal 52 to be greater in magnitude than the parallel directional component of the incident signal, and the perpendicular directional component of the reflected signal to be lower in magnitude than the perpendicular directional component of the incident signal. In other words the reflected trajectory is shallower than the incident trajectory. As a result, the reflected signal propagates in a more axial direction and therefore is less disturbing to the surrounding community than is nonaxially propagating noise.

The prescribed direction of reflection need not be the same direction for all portions of the liner. This is evident from the foregoing examples in which portion 3-3 of the liner reflects the incident noise signal in a prescribed direction that is less axial and more radial than the incident signal whereas portion 6-6 of the liner reflects the incident signal in prescribed direction that is more axial and less radial than the incident signal.

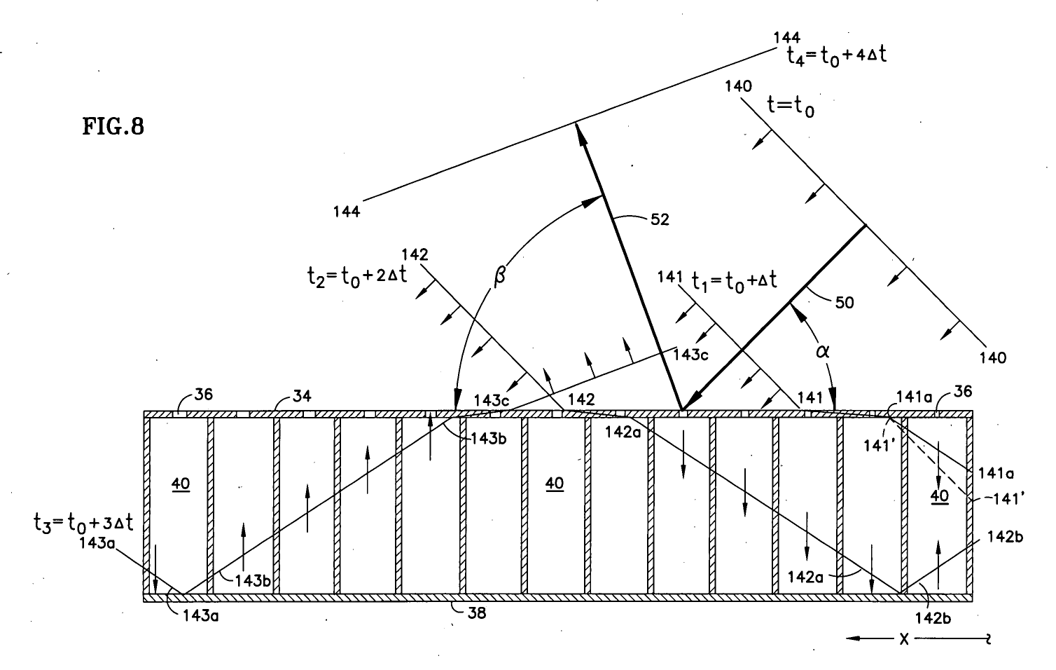

FIG. 8 schematically illustrates the physical behavior of the inventive acoustic liner described above. In FIG. 8, the impedance of the surface varies such that the liner time constant, τ, varies linearly according to the equation

$$τ = {τ}_{0} - \frac{x / c}{tan α} ( 1 - \frac{tan α}{tan ( α + γ )} ) \qquad ( 11 )$$

where x is the distance along the face sheet such that x increases with increasing distance away from the noise source 28, τ₀ is the time constant at an arbitrary value of x (typically at the extremity of the liner closest to the noise source) α is the angle of incidence, γ is one-half the difference between the prescribed reflection angle β (relative to the face sheet) and a specular angle of reflection βₛ and c is the speed of sound. For the x coordinate system shown in FIG. 8, both the time constant and the impedance decrease with increasing distance from the noise source.

Continuing to refer to FIG. 8, a sound wave represented by incident noise signal 50 approaches the liner surface at an incidence angle α. Line 140-140 depicts a line of equal phase (e.g. maximum pressure crest) at time t₀. At a later time, t₁=t₀+Δt, the wave has progressed forward by a distance s₁=c(Δt) where c is the speed of propagation. The portion of the wave that has not yet entered the liner at time t₁ is depicted by line segment 141-141. The part of the wave that had been closest to the liner face at time t₀ is depicted by line segment 141a-141a. This wave portion 141a-141a, which has now entered the resonator chambers, has been delayed by the face sheet and refracted due to the linearly varying time delay imposed on the wavefront by the nonuniform, linearly varying impedance. Line segment 141′-141′ indicates the position of the wavefront in the liner if the wavefront had been delayed by a constant amount (i.e. uniform impedance distribution at the liner face sheet). The vertical distance between 141a-141a and 141′-141′ diminishes with increasing x because the time delay imposed by propagation of the wave through the liner face decreases in the direction of increasing x. At time t₂=t₀+2Δt, the portion of the wave which has not yet entered the liner is depicted by line segment 142-142. The portion of the wave represented by 142a-142a has entered the liner, been delayed and refracted as described above, and is still progressing toward the backwall. Another part of the wave, indicated by segment 142b-142b, has struck the backwall and has rebounded toward the face sheet. Thus, at time t₂ the wave is depicted by line segments 142-142, 142a-142a, and 142b-142b. At time t₃=t₀+3Δt, the wave portion 143a-143a is progressing toward the backwall. Portion 143b-143b has rebounded from the backwall. Portion 143c-143c has exited through the face sheet and has been further delayed and refracted as already described. At time t₄=t₀+4Δt, the wave has completely exited the liner and is depicted by line 144-144. The angle β of the reflected signal 52 is thus seen to be equal to a α+2γ. For the example shown in FIG. 8, the incidence angle α is about 45 degrees, γ is about 12.5 degrees, and the angle of reflection β relative to the face sheet is about 70 degrees. The designer can use the relationships β=α+2γ and

$$τ = {τ}_{0} \pm \frac{x / c}{tan α} ( 1 - \frac{tan α}{tan ( α + γ )} )$$

to define how the time constant τ, and therefore the impedance, should vary as a function of distance in order to prescribe a desired angle of reflection β at any given location within the duct. As already noted, an impedance that decreases with increasing distance from the noise source vectors the sound wave more radially as seen in FIGS. 2, 3 and 8 (or even back towards the source for a large enough increase). An impedance that increases with increasing distance from the noise source vectors the sound wave in a more axial direction within the duct as seen in FIGS. 5 and 6.

The prescribed direction will ordinarily be a nonspecular direction relative to the face sheet, however some portions of the liner may have a spatially uniform impedance to achieve a specular reflection relative to the face sheet if such a direction is consistent with noise attenuation goals or if it is necessary to form a transition between portions of the liner that each reflect nonspecularly relative to the face sheet.

The above examples show incident noise signals with both axial and radial directional components. However noise signals radiating from engine fans typically exhibit spinning modes that propagate toward the liner with a spiral motion. Such incident sound waves have a circumferential component in addition to axial and radial components. Therefore, the acoustic impedance may vary in the circumferential direction instead of, or in addition to, varying in the axial direction. This is seen in FIG. 9 where the areas of the holes 36, and therefore the porosity of the face sheet, change in both the axial and circumferential directions to redirect the reflected noise signal in the most desirable prescribed direction.

Although the examples discussed herein show linearly varying impedance, the impedance may be distributed nonlinearly.

The foregoing discussion and accompanying illustrations describe the use of varying diameters (areas) of holes 36 to spatially vary the face sheet porosity thereby achieving the desired non-uniform acoustic impedance distribution. However the same effect can be achieved by varying the density of holes having uniform diameters, or by a combination of varying hole size and density. For conventional liners with hole diameters on the order of about 0.10 inches (0.25 centimeters) variation of hole diameter may be the most desirable approach because the uniform spacing between the holes makes it easier to ensure that there is at least one hole 36 leading to each resonator chamber 40. However with a micro-perforated liner in which the hole diameters can be on the order of 0.004 to 0.010 inches (0.010 to 0.025 cm.) it may be more desirable to vary the density of the holes while maintaining the hole diameter constant.

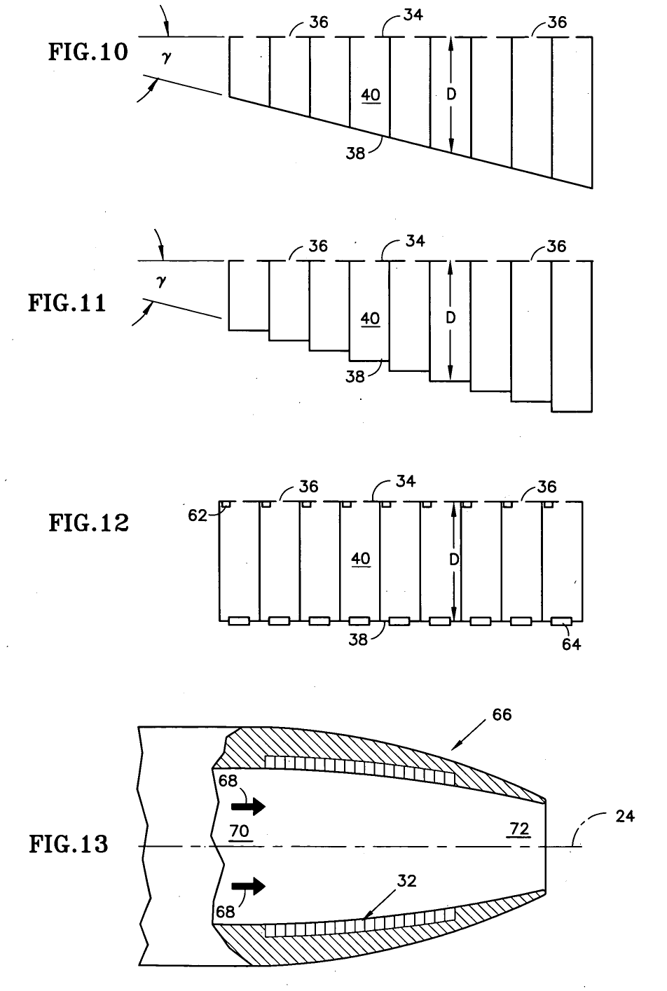

As seen in FIGS. 10 and 11, the nonuniform impedance may be used in combination with an oblique backwall or a stepped backwall, both of which are described in more detail in the patent application incorporated herein by reference.

Referring to FIG. 12, the present invention may be used in combination with an active backwall. As illustrated in FIG. 12, an active backwall includes vibratory elements 64 such as piezoelectric flat panel actuators. A control system responds to acoustic sensors 62 by signaling the actuators to vibrate at an amplitude and a phase angle (relative to an incident noise signal) that causes the impedance of the liner to vary with time and to do so in a way that optimizes attenuation of an incident noise signal. The use of the variable impedance backwall in combination with active elements may reduce the operational demands on the active elements leading to an accompanying reduction in the power required to drive them.

The invention, although described in the context of a turbine engine inlet duct, is equally applicable to other types of ducts, including a turbine engine exhaust duct. As seen in the schematically illustrated exhaust duct 66 of FIG. 13, the noise source is hot, high velocity exhaust gases 68 entering upstream end 70 of the duct. The noise propagates downstream and toward the open or downstream end 72 of the duct.

In addition, although the examples shown in the figures and discussed in the text assume that the phase speed (wave propagation speed) is equal to the thermodynamic sound speed, it should be recognized that the concept described herein works equally well when the wave propagation speed deviates significantly from the thermodynamic sound speed, which can occur for sound propagation in lined ducts.

Although this invention has been shown and described with reference to a specific embodiment thereof, it will be understood by those skilled in the art that various changes in form and detail may be made without departing from the invention as set forth in the accompanying claims.

I claim:

1. A fluid handling duct including an acoustic liner having a spatially nonuniform acoustic impedance, the impedance being spatially distributed to direct sound waves incident on the backwall in a prescribed direction relative to the face sheet.

2. The duct of claim 1 wherein the liner includes a face sheet having a spatially nonuniform porosity.

3. The duct of claim 1 wherein the prescribed direction is nonspecular relative to the face sheet.

4. The duct of claim 1 wherein the impedance increases with increasing distance from a noise source.

5. The duct of claim 1 wherein the impedance decreases with increasing distance from a noise source.

6. The duct of claim 1 wherein the duct is substantially circular when viewed parallel to the axis.

7. The duct of claim 6 wherein the prescribed direction has axial and radial components.

8. The duct of claim 1 wherein the incident sound waves and the prescribed direction are both describable by at least a directional component parallel to the face sheet and a directional component perpendicular to the face sheet and wherein the parallel directional component of the prescribed direction is lower in magnitude than the parallel directional component of the incident sound waves and the perpendicular directional component of the prescribed direction is greater in magnitude than the perpendicular directional component of the incident sound waves.

9. The duct of claim 1 wherein the incident sound waves and the prescribed direction are both describable by at least a directional component parallel to the face sheet and a directional component perpendicular to the face sheet and wherein the parallel directional component of the prescribed direction is greater in magnitude than the parallel directional component of the incident sound waves and the perpendicular directional component of the prescribed direction is lower in magnitude than the perpendicular directional component of the incident sound waves.

10. The duct of claim 1 wherein the duct is a turbine engine inlet duct and wherein a compressor downstream of the inlet is a noise source that introduces noise into the duct.

11. The duct of claim 1 wherein the duct is a turbine engine exhaust duct and wherein a stream of exhaust gases entering an upstream end of the duct is a noise source.

12. The duct of claim 1 wherein the liner has a backwall having an oblique orientation relative to the face sheet.

13. The duct of claim 1 wherein the liner has a stepped backwall.

14. The duct of claim 1 wherein the liner comprises an active backwall.

15. The duct of claim 1 wherein an array of resonator chambers occupies the lateral space between the face sheet and the backwall.

16. The duct of claim 1 wherein the liner has a time constant τ that varies with distance x according to the equation:
$$τ = {τ}_{0} \pm \frac{x / c}{tan α} ( 1 - \frac{tan α}{tan ( α + γ )} )$$
where α is an incidence angle and γ is one-half the difference between a prescribed angle of reflection and a specular angle of reflection, the incidence angle and prescribed angle of reflection being taken relative to the face sheet and τ₀ is a value of the time constant at an arbitrary value of x.

17. The duct of claim 1 wherein the liner has a face sheet perforated by holes, the holes being at least one of:
a) nonuniformly spatially distributed and
b) nonuniformly sized.
